(19) United States
(12) Patent Application Publication
(10) Pub. No.: US 2024/0196509 A1
(43) Pub. Date: Jun. 13, 2024

(54) Electrode Made by Surface Increase of Cooling Surfaces Connecting Emitter Cutter Tip (Insert) for Plasma Cutting Torches with Copper Electrode Body

(71) Applicant: Ahmet YILDIRIM, Bornova, Izmir (TR)

(72) Inventor: Ahmet YILDIRIM, Bornova, Izmir (TR)

(21) Appl. No.: 18/554,583

(22) PCT Filed: Apr. 6, 2022
(86) PCT No.: PCT/TR2022/050304

§ 371 Date: Oct. 9, 2023

(30) Foreign Application Priority Data
Apr. 21, 2021 (TR) 2021/006962

(51) Int. Cl. H05H 1/34; B23K 10/00

(52) U.S. Cl. CPC H05H 1/3436; B23K 10/00

(57) ABSTRACT

Disclosed is a plasma cutting torch copper-bodied electrode connecting the emitter cutter tip for plasma cutting torches with copper-bodied electrode body, prolonging the life and efficiency thereof with the surface increase of cooling surfaces, the electrode having an emitter cutter tip with surface increase channels formed with indentations/protrusions on the side surface thereof and surface increase channels formed with indentations/protrusions on the upper surface thereof and having a diameter enlarging in the form of a bowl from the outer diameter to the tip. A downstream electrode body carries the emitter cutter tip with a cavity on which this emitter cutter tip is secured, wherein by securing the emitter cutter tip on the cavity on the copper-bodied electrode body, the copper-bodied electrode with the liquid cooling system in the plasma torch is formed to cut the metallic piece.

### TECHNICAL FIELD

The invention relates to plasma cutting torch copper-bodied electrode connecting the emitter cutter tip (insert) for plasma cutting torches with copper-bodied electrode body, prolonging the life and efficiency thereof with the surface increase of cooling surfaces.

### DESCRIPTION OF THE INVENTION

For plasma cutting torches with automatic or manual liquid cooling system or air cooling system, an arc plasma cutting torch is based on a similar architecture, which is equipped with an electrode consisting of an emitter cutter tip, a gas diffuser, and a body to which a nozzle for narrowing the plasma jet is secured.

In general, the copper-bodied electrodes used in these plasma torches consist of a copper-bodied in which an electron-emitting cutter tip or emitter cutter tip is secured. The cutter tip is tungsten or hafnium or zirconium. This emitter cutter tip, typically cylindrical in shape, is secured by stamping, crimping, or by hard-driving into a cavity such as a blind hole (the cavity where the emitter cutter tip is secured) arranged at the downstream tip of the electrode body.

Pressurized coolant coming from the submersible pipe, which is connected to the plasma cutting torch with the circulation system discharge line, and from the center of the cutting torch, where it is connected with the channels in the torch, through various connecting methods, is carried by the submersible pipe to a close distance to the bottom of the blind hole of the copper-bodied electrode; and returns to the cooling system by the coolant circulation return line, to which the return channels in the plasma cutting torch are connected in an upward direction between the electrode blind hole outer part and the outer diameter of the submersible pipe by performing the cooling washing. All liquid-cooled plasma cutting torches are used in the past and today with similar architectures of which technique is known by the companies that produce copper-bodied electrodes.

It is well known that during the plasma cutting process, an emitter cutter tip (insert) is exposed to particularly very high temperatures and suction forces produced more or less by the arc plasma jet, which begins to take root in that emitter cutter tip. Inevitably, the metal or metal alloy forming the emitter cutter tip will significantly evaporate, be thrown into the plasma jet, and therefore be abraded with the formation of a crater inside said emitter cutter tip.

With this abrasion, this more or less rapid deterioration of the tips of the copper-bodied electrodes of plasma torches is almost inevitable and presents a real problem on an industrial scale. Because it requires frequent replacement of the torch electrodes, also affects the efficiency of the cutting process, so the replacement of the electrode stops the system, stops the cutting process, and incurs additional costs. Therefore, when an emitter cutter tip fails, it is not possible to replace only the emitter cutter tip, and it is the entire electrode that must be replaced.

When the additional materials whose thermal conductivity coefficients are very low compared to the material forming the copper electrode body and for example hafnium and copper, of which purity values are as high as possible, hafnium has a thermal conductivity close to 5.75 percent compared to the thermal conductivity of copper, which is known to prevent the high heat transfer and better cooling due to the very high temperatures caused by the initiation of the arc plasma jet and the low thermal conductivity of the materials of which the insert is made.

The invention has been made in order to minimize the aforementioned disadvantages and to find a solution to this problem.

Due to the high thermal and electrical conductivity of silver compared to copper, electrodes made of silver and/or silver/copper and/or copper-silver alloys have slightly longer lives than electrodes made of copper. However, the cost of silver is much higher than that of copper, which significantly increases the cost of electrodes. With the cooling surface increase channels of our invention, the cutting electrode whose service life is extended by two times or more creates an alternative to the cutting electrode, the body of which is made of copper, and this reduces the costs of the electrodes.

For this purpose, with the surface increases obtained with the indentations/protrusions opened at equal intervals parallel to each other on an upward cylindrical outer surface from the electrode tip section secured to a lower tip part of the copper-bodied electrode body of the emitter cutter tip, the emitter cutter tip exposed to high heat, from the extreme point where the cutting process starts, is cooled with the increase in the heat transfer surfaces required for cooling from the body on which it is secured from the extreme point, and thusly a better cooling of the emitter cutter tip is exposed to high heat is ensured, the amount evaporated due to the high heat is reduced, and thus the working life is extended.

With this purpose, with surface increases from the copper-bodied electrode tip section of the emitter cutter tip secured to a lower tip section of the copper-bodied electrode body, to an upwardly oriented bowl and cylindrical outer surface, from the tip section to the end of the cylindrical upper tip of the cutter tip in the upper direction, consisting of the same profile section parallel to each other, having equally spaced indentations/protrusions, with a heat transfer surface increase of more than 80%; and with surface increases to the cylindrical upper section of the cutter tip, from the outer diameter to the center, in parallel, consisting of the same profile section, shrinking towards the center at equal intervals, with a heat transfer surface increase of more than 80%, the emitter cutter tip exposed to high heat during operation, is cooled better, the amount of mass loss lost by evaporation and phase transitions due to high temperature is reduced, and the working life is extended.

### DRAWINGS FOR UNDERSTANDING OF THE INVENTION

FIG. 1A sectional view of the plasma cutting torch copper-bodied electrode with a liquid cooling system with the surface increase by means of indentations/protrusions of the cooling surfaces connecting the emitter cutter tip to the copper-bodied electrode body;

FIG. 2A sectional view of the surface-increased state of the cooling surfaces by means of indentations/protrusions connecting the emitter cutter tip to the copper-bodied electrode body;

FIG. 3A top, sectional view of the surface-increased state of the cooling surfaces by means of indentations/protrusions connecting the emitter cutter tip to copper-bodied electrode body;

FIG. 4a Cross-sectional view in which the root abrasion value is 1.9 mm when measured from the center of the crater, constituted in the emitter cutter tip by the arc plasma jet of the emitter cutter tip of which surface is increased by means of indentations/protrusions of the cooling surface connected to the copper-bodied electrode body,

FIG. 4b Cross-sectional view in which the root abrasion value is 2.38 mm when measured from the center of the crater, constituted in the emitter cutter tip by the arc plasma jet of the emitter cutter tip of which surface is increased by means of indentations/protrusions of the cooling surface connected to the copper-bodied electrode body,

### REFERENCE NUMERALS FOR UNDERSTANDING THE INVENTION

1. Copper-bodied electrode with the liquid cooling system in the plasma torch to cut the metallic piece,
2. A downstream, copper-bodied electrode body carrying the emitter cutter tip,
3. Emitter cutter tip,
3a. Surface increase channels formed with indentations/protrusions on the side surface thereof
3b. Surface increase channels formed with indentations/protrusions on the upper surface thereof
3c. A diameter enlarging in the form of a bowl from the outer diameter to the tip
4. A cavity in which the emitter cutter tip is secured to the copper-bodied electrode body
5. Coolant submersible pipe
A. Bowl depth

### Detailed Description of the Invention

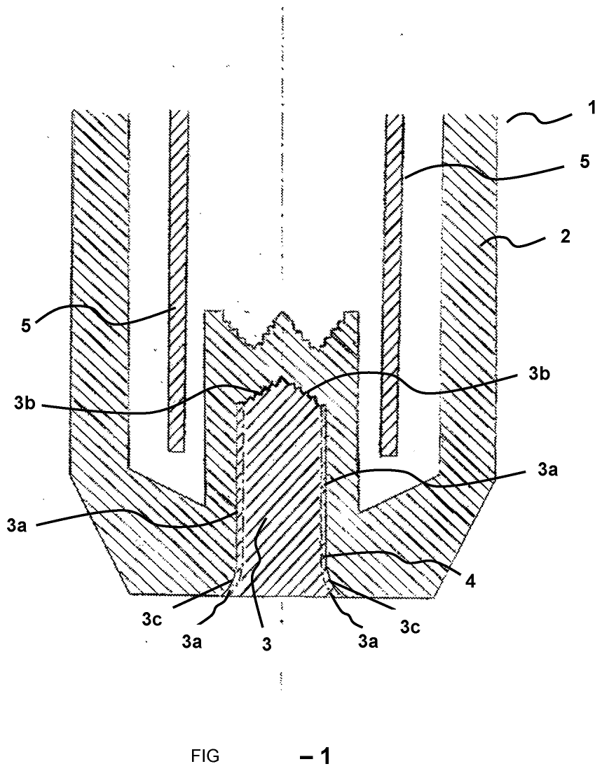

The invention is a plasma cutting torch copper-bodied electrode connecting the emitter cutter tip for plasma cutting torches with copper-bodied electrode body, prolonging the life and efficiency thereof with the surface increase of cooling surfaces, characterized in that it comprises of an emitter cutter tip with surface increase channels (3a) formed with indentations/protrusions on the side surface thereof and surface increase channels (3b) formed with indentations/protrusions on the upper surface thereof and having a diameter enlarging in the form of a bowl from the outer diameter to the tip, and by a downstream electrode body (2) carrying the emitter cutter tip (3) with a cavity (4) on which this emitter cutter tip (3) is secured (FIG. 1).

A cavity (4) is drilled to the extent of the emitter cutter tip (3) driving length in an upward direction from the cavity (4) bowl (3c) depth (A) upper line where the emitter cutter tip is secured with a relatively low value compared to the cooling channels (3a) thread minor diameter opened on the cylindrical side surface of the emitter cutter tip (3). The bowl (3c) form, which extends from the upper line of the bowl (3c) depth (A) to the tip of the electrode (1), is processed in a small manner in the copper-body electrode (1), in the cavity (4) where the emitter cutter tip is secured, with slight difference from the form that follows. The cooling channel indentations/protrusions (3a) of the bowl-shaped diameter (3c) of the copper-bodied emitter cutter tip (3) are shaped and mounted in the cavity (4) where they are secured during the driving process under vacuum.

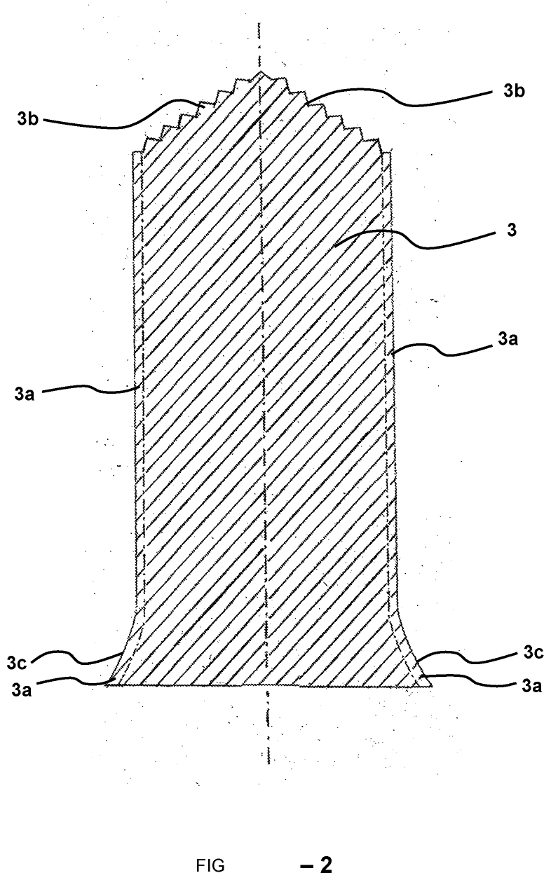

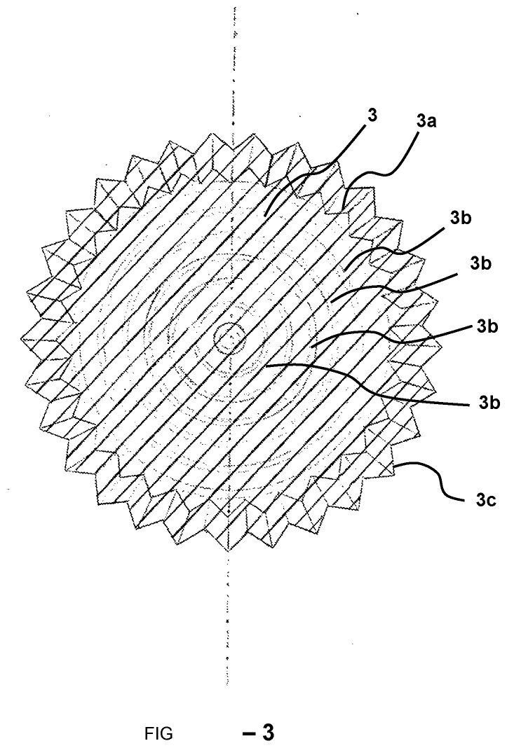

The invention is a plasma cutting torch copper-bodied electrode connecting the emitter cutter tip for plasma cutting torches with the copper-bodied electrode body, prolonging the life and efficiency thereof with the surface increase of cooling surfaces, as seen in FIG. 2, the emitter cutter tip (3) made of the arc formed by being exposed to the suction forces produced by the arc plasma jet of the copper-bodied electrode (1) and of tungsten, hafnium, or zirconium conducting the metal cutting process has surface increase channels (3a, 3b) formed with indentations/protrusions on the side and upper surfaces thereof for ensuring more cooling thereof upon exposure to high heat during its operation (FIG. 2, FIG. 3). The copper-bodied electrode with a liquid cooling system in the plasma torch is created by securing the emitter cutter tip (3), on which surface increase channels (3a, 3b) are formed for cooling purposes on these side and upper surfaces, to the cavity (4) on the copper electrode body (2) to cut the metallic piece (FIG. 1).

The root abrasion depth formed by the arc plasma jet on the emitter cutter tip (3) was determined to be 1.9 mm for the same shapes made with 260 Ampere liquid-cooled copper-bodied electrode, with system catalog cutting parameters, and 25 mm of thick and A1-quality soft iron sheet cutting, at the end of 1184 blasting, with the removal of the copper-bodied electrode from the electrode tip level in the measurement made from the crater center.

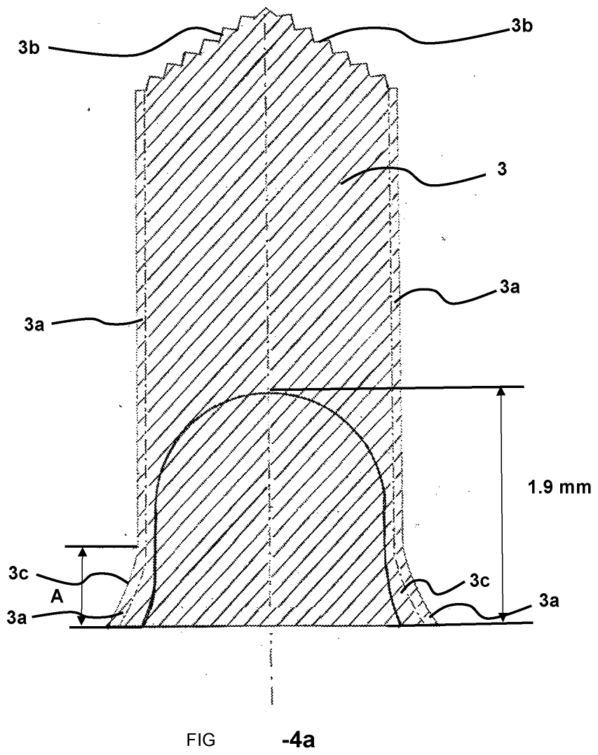

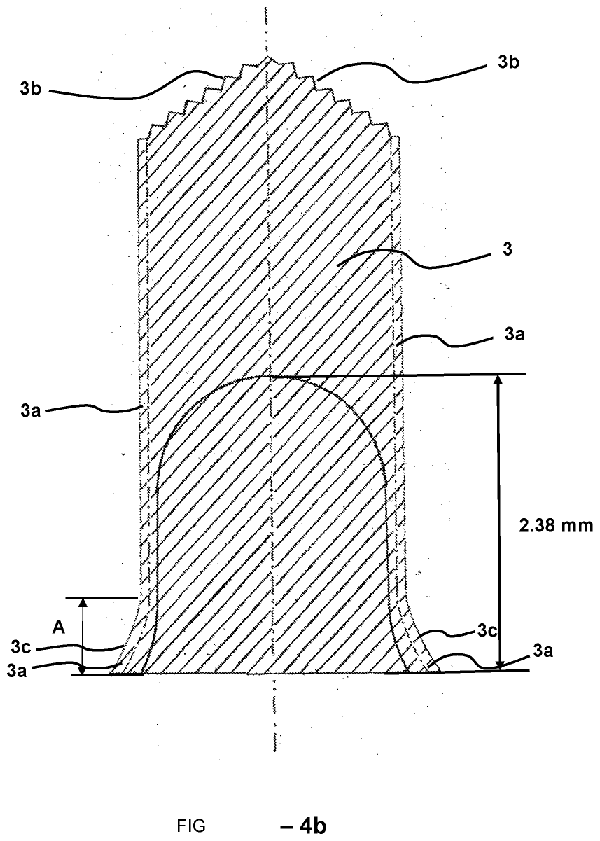

The root abrasion depth formed by the arc plasma jet on the emitter cutter tip (3) from the electrode tip level, with reconnection of the copper-bodied electrode, the continuation of the cutting with the same shapes' system catalog cutting parameters, the performance of 648 more blasts, was calculated as 2.38 mm (FIG. 4b).

This difference of values (2.38 (−) 1.9) shows that 648 blastings were obtained at 0.48 mm of abrasion.

In the calculation made according to these values, when the copper-bodied electrode reached a depth of 1.9 mm from the first point of cutting, 2565 blasts would have been obtained if it went with a linear decrease, while 1184 explosions were obtained due to the depth lost due to excessive evaporation at 1.9 mm.

This shows that the rate of evaporation and loss of mass decreases logarithmically as it provides better cooling as it approaches the liquid cooling zone. This situation, in which cooling is of such importance, with a surface increase of around 80% from the surface increase channels (3a,3b) formed by the indentations/protrusions on the side and upper surfaces of the emitter cutter tip (3), which corresponds to the cavity (4) where the emitter cutter tip (3) is secured to the copper-bodied electrode body and from the extreme point where the emitter cutter tip (3) starts cutting, during its fixation to the copper-bodied electrode body (2), which is connected with these indentations/protrusions, a surface increase of around 80% was achieved on the securing surfaces and the life of the emitter cutter tip (3) was extended with the increase in cooling transmission (FIG. 1).

In the blasting and cutting with crater liquid-cooled system formed by the arc plasma jet starting to take root from the first starting level of the cutting of the emitter cutter tip (3), with a 260 Ampere electrode, to a 25 mm of thickness, with an A1-quality soft iron sheet, it was measured that a hemisphere or hemispherical crater was formed at 1.9 mm abrasion measurement from the crater center, and the rim of the crater was around 1.84 mm in diameter. This diameter was measured around 1.9 mm in diameter 0.4 mm above the copper-bodied electrode tip level. A conical abrasion of approximately 1 degree is observed at the depth distance from 1.9 mm to 1.84 mm in these two diameter differences. In the abrasion of the emitter cutter tip (3), in the section from the tip level of 0.4 mm after the depth to the tip level of the copper-bodied electrode, a 1.9 mm diameter expanded towards the outside in the form of a bowl (FIG. 5a). This abrasion action of the copper electrode body (2), which is furthest from cooling, occurs after a certain amount of work on all cutting electrodes with different diameters depending on the amperage.

For this reason, a profile has been created by adding the diameter of the bowl tip level that the emitter cutter tip (3) can be opened according to the amperage and the indentation depth tolerance to the emitter cutter tip (3) at the depth of the bowl (FIG. 4a, FIG. 4b).

At the level of the bowl depth (A) of the emitter cutter tip (3), it can go straight or conical about 1-2 degrees from the outer diameter of the emitter cutter tip (3) with respect to the bottom-up centerline to the upper surface of the emitter cutter tip (3) (FIG. 4a, FIG. 4b).

At the level of the bowl depth (A) of the emitter cutter tip (3), the diameter of the emitter cutter tip (3) was enlarged in proportion to the depth of the indentations/protrusions equally spaced from the outer diameter of the emitter cutter tip (3) to the flat or conical end of the emitter cutter tip (3) in the upward direction (FIG. 4a, FIG. 4b).

It can be formed with any number of indentations/protrusions according to the diameter of the emitter cutter tip (3) calculated according to the maximum cutting amperage, with any suitable geometric profile section to create the highest surface increase, and with any suitable geometric extensions. It is possible to create indentations/protrusions on the surfaces of the emitter cutter tip (3) in suitable CNC machines with precise tolerances with a precision knurling system equipped with profiled knurling rollers to be obtained with suitable hard metal material on suitable benches with high precision CNC control or profile milling cutters made of hard metal material, and to create indentations/protrusions on the upper surface of the emitter cutter tip (3) with a profile knife (FIG. 2, FIG. 3).

Depending on the geometrical section of the channels (3a, 3b) opened by knurling, the number of channels, the depth to which they will be driven, and the amount of sawdust to be scraped and swept during driving, an appropriate headroom is left where the tip is driven into the body of the copper-bodied electrode and secured to the copper electrode body.

Even though there are other methods, the current method of using the emitter cutter tip (3) on the copper-bodied electrode body (2) is to drive the same by vacuuming. Line vacuum is the fastest and least costly method.

The electrode life of the invention is increased in copper-bodied electrodes (1) used in torches with a liquid cooling system and the copper-bodied electrodes used in air-cooled mechanized system torches.

The fact that the emitter cutter tip (3) indentations/protrusions lead to low costs in terms of manufacturing process time provides much more advantage compared to an electrode with extended life.

A problem in plasma cutting is angled and burr cutting in the metal cutting of copper-bodied electrodes; the cutting quality obtained and the cutting angle is low when the cutting of the copper-bodied electrode is started; there is no or almost no burr on the lower cutting surface of the cut surface; these negativities increase towards the end of the copper-bodied electrode life, because the tip of the electrode (1) being produced enlarges gradually by melting in the form of a bowl and the kerf gap gradually increases. Thanks to the cooling surface increase channels (3a, 3b) made with the invention, better cooling is achieved, the life of the copper-bodied electrode (1) becomes 2 fold or more, the part enlarging by melting in the form of a bowl in a lower level and at a longer time further reduces these problems, and this allows to obtain a better quality cut. In case of excessive bowl enlargement, the cutting operator has to reduce the cutting speed, which means longer cutting time and increased cutting cost.

Due to the high thermal and electrical conductivity of silver compared to copper-bodied, electrodes made of silver and/or silver/copper and/or copper-silver alloys have slightly longer lives than electrodes made of copper, particularly in terms of lives in high amperages. However, the cost of silver is much higher than that of copper, which significantly increases the cost of electrodes. With the cooling surface increase channels (3a, 3b) of our invention, the copper-bodied cutting electrode (1) whose service life is extended by two times or more creates an alternative to the cutting electrode (1), the body of which is made of copper, and this has reduced the costs in the copper-bodied electrodes.

It has been known by the manufacturers for many years that the emitter cutter tip (3) used in plasma cutting copper-bodied electrodes generally contains cylindrical parts or other geometric shapes (for example, conical) and similar geometric shapes, however, no formation has been seen in any companies with the idea of the present invention, thanks to the heat transfer surface increase channels (3a) that extend in the bowl (3c) in parallel to each other and/or at the same angle to each other, consisting of the same profile section, obtained by indentations/protrusions opened at equal intervals in a way to provide the highest surface increase; and the highest heat transfer surface increase channels (3b) that extend in parallel to each other from the outer diameter on the upper section of the emitter cutter tip (3), consist of the same profile section, and shrink towards the center at equal intervals, other than the invention which provides with a geometrical structure allowing the reduction of masses lost due to evaporation of phase transitions, and the prolonging of the copper-bodied electrodes (1).

1. A plasma cutting torch copper-bodied electrode connecting an emitter cutter tip for plasma cutting torches with copper-bodied electrode body, prolonging the life and efficiency thereof with a surface increase of cooling surfaces, the electrode comprising an emitter cutter tip with surface increase channels formed with indentations/protrusions on a side surface thereof and surface increase channels formed with indentations/protrusions on an upper surface thereof and having a diameter enlarging in the form of a bowl from the outer diameter to the tip, and a downstream electrode body carrying the emitter cutter tip with a cavity on which this emitter cutter tip is secured.

2. The plasma cutting torch copper-bodied electrode connecting the emitter cutter tip for plasma cutting torches with copper-bodied electrode body, prolonging the life and efficiency thereof with the surface increase of cooling surfaces according to claim 1, wherein the emitter cutter tip is made of the arc formed by being exposed to the suction forces produced by the arc plasma jet during the operation of the copper-bodied electrode and of tungsten, hafnium, or zirconium conducting the metal cutting process has surface increase channels formed with indentations/protrusions on the side surface thereof and surface increase channels formed with indentations/protrusions on the upper surface thereof for ensuring more cooling thereof in order to use the same for a longer period of time without melting rapidly upon exposure to high heat during its operation.

3. The plasma cutting torch copper-bodied electrode connecting the emitter cutter tip for plasma cutting torches with copper-bodied electrode body, prolonging the life and efficiency thereof with the surface increase of cooling surfaces according to claim 1, wherein a profile is formed during the manufacture of said emitter cutter tip, by adding the diameter of the bowl tip level that can be opened according to the amperage and the indentation/protrusion depth tolerance at the bowl depth to the emitter cutter tip.

4. The plasma cutting torch copper-bodied electrode connecting the emitter cutter tip for plasma cutting torches with copper-bodied electrode body, prolonging the life and efficiency thereof with the surface increase of cooling surfaces according to claim 1, wherein the emitter cutter tip has an enlarged diameter in proportion to the depth of the indentations/protrusions that are opened at equal intervals from the outer diameter of said emitter cutter tip at the level of the bowl depth to the flat or conical end of the emitter cutter tip in the upward direction.

5. A plasma cutting torch copper-bodied electrode connecting the emitter cutter tip for plasma cutting torches with copper-bodied electrode body, prolonging the life and efficiency thereof with the surface increase of cooling surfaces according to claim 1, wherein the emitter cutter tip has a cavity secured to the copper-bodied electrode body with a headroom depending on the geometrical section of the channels opened by knurling, the number of channels, the depth to which they will be driven, and the amount of sawdust to be scraped and swept during driving.

6. The plasma cutting torch copper-bodied electrode connecting the emitter cutter tip for plasma cutting torches with copper-bodied electrode body, prolonging the life and efficiency thereof with the surface increase of cooling surfaces according to claim 1, wherein the copper-bodied electrodes used in torches with liquid cooling system and the copper-bodied electrodes used in air cooled mechanized system torches have an emitter cutter tip with extended life.

7. The plasma cutting torch copper-bodied electrode connecting the emitter cutter tip for plasma cutting torches with copper-bodied electrode body, prolonging the life and efficiency thereof with the surface increase of cooling surfaces according to claim 1, wherein the surface increase channels are formed with indentations/protrusions on the side and upper surfaces thereof as well as (insert) emitter cutter tips side and upper surfaces and the emitter cutter tip of which life is increased by enlarging the diameter of the emitter cutter tip enlarging in the form of a bowl from the outer diameter to the tip.

8. The plasma cutting torch copper-bodied electrode connecting the emitter cutter tip for plasma cutting torches with copper-bodied electrode body, prolonging the life and efficiency thereof with the surface increase of cooling surfaces according to claim 1, wherein the emitter cutter tip can be formed with any number of indentations/protrusions according to the diameter of the emitter cutter tip calculated according to the maximum cutting amperage, with any suitable geometric profile section to create the highest cooling surface increase, and with any suitable geometric extensions.

9. A plasma cutting torch copper-bodied electrode connecting the emitter cutter tip for plasma cutting torches with copper-bodied electrode body, prolonging the life and efficiency thereof with the surface increase of cooling surfaces according to claim 1, wherein the cooling surface increase channels formed by indentations/protrusions on the side and upper surfaces of the emitter cutter tip secured to the cavity where the emitter cutter tip is secured the copper-bodied electrode body, an emitter cutter tip having surface increase from the most extreme point where the emitter cutter tip starts cutting, much more cooling thanks to this cooling surface increase, thusly reduced evaporation and extended life, and thusly extended service life.
